(19) United States
(12) Patent Application Publication
(10) Pub. No.: US 2006/0093316 A1
(43) Pub. Date: May 4, 2006

(54) Data recording/reproducing device, and data processing method and program

(75) Inventor: Yoshimi Enomoto, Kashiwa-shi, Chiba (JP)

Correspondence Address: PHILIPS INTELLECTUAL PROPERTY & STANDARDS, P.O. BOX 3001, BRIARCLIFF MANOR, NY, 10510, US

(73) Assignee: koninklijkle phillips electronics n.v.

(21) Appl. No.: 10/540,314

(22) PCT Filed: Dec. 1, 2003
(86) PCT No.: PCT/IB03/05831

§ 371 Date: Jun. 21, 2005

(30) Foreign Application Priority Data
Dec. 26, 2002 (JP) 2002-378245

(51) Int. Cl. H04N 5/91

(52) U.S. Cl. 386/66

(57) ABSTRACT

To perform the time shift reproducing while causing the contents-provider's intention of “copy prohibition” to be reflected when the copy prohibiting information is added to an analog AV signal inputted to a processor. A processor (10) receiving analog video signal (Sv?in#191) to which copy control information is added is provided with a controller (33) having means for instructing to start storing data in a storage (15) when copy control information with copy prohibiting information is received and means for instructing to start reproducing the video data stored in the storage (15) before end of storing. The storage (15) has means for erasing from the storage (15) a reproduced portion of the video data in the storage immediately after reproduction and means for erasing the video data in the storage when reproduction has not been started before the end of storing or when reproducing the video data is not being performed at the time of the end of storing.

### BACKGROUND OF THE INVENTION

1. Field of the Invention

The present invention relates to a data recording/reproducing device provided with a processor that processes input data including an analog video signal to which copy control information is added, and a pertinent data processing method and program, and more particularly, to a data recording/reproducing device, and data processing method and program capable of performing storing and reproducing of data concurrently.

2. Description of Related Art

In recent years, demands have been increased for so-called time shift reproducing where reception of a television program on the air is temporarily stopped and then resumed, or a television program on the air is recorded while reproducing the program from the beginning at any time. Then, data recording/reproducing devices are becoming widespread which have a random-access storage medium such as a hard disk device and enable the above-mentioned time shift reproducing.

Generally, in a recording/reproducing device that records in digital format the digital content including video and audio such as digital broadcast, when performing the time shift reproducing, a processor of the device receives digital input signals to which is added time shift information indicating that the signals are allowed to be stored in a storage medium, for example, for a month or only a day, and copy control information such as CGMS (Copy Generation Management System)-G data, and processes the signals according to both the time shift information and copy control information. Meanwhile, when analog audio video signals are inputted to the data recording/reproducing device and undergo the time shift reproducing, the analog signals do not include the time shift information as described above, and only include a macrovision signal and copy control information such as CGMS-A data, and the processor processes the signals according to the copy control information.

In data recording/reproducing devices currently on the market, in either case of processing digital signals or of processing analog signals, the devices are designed to be able to perform recording and reproduction only when the copy control information with copy permitting information is added to audio video input signals. For such a system, it is strongly desired to implement the time shift reproducing even when the copy control information with copy prohibiting information is added to input audio video signals.

Then, data recording/reproducing devices are proposed which enable a television program to be watched later after the on-air time of the program while causing the contents-provider's intention of “copy prohibition” to be reflected, even when receiving audio video signals to which is added copy control information with copy prohibiting information in receiving digital signals (for example, see International Publication WO99/46933, Japanese Laid-Open Patent Publication No. 2001-245223).

However, as described above, since processing methods are different between digital recording and recording of analog input signals because additional information is different therebetween, there arises a problem that the devices as proposed in the documents are not applied to processing of analog signals. Accordingly, it has been still desired strongly to implement the time shift reproducing even when the copy prohibiting information is added to input analog audio video signals.

### SUMMARY OF THE INVENTION

In view of the foregoing, it is an object of the invention to provide a data recording/reproducing device, and data processing method and program capable causing the contents-provider's intention of “copy prohibition” to be reflected and performing the time shift reproducing when the copy prohibiting information is added to an analog audio video signal inputted to a processor.

A data recording/reproducing device according to the present invention is a data recording/reproducing device provided with a processor for receiving data including analog video data and additional information to control a copy of the video data and for processing the data, and is characterized in that the processor comprises a storage capable of storing the received video data, means for instructing to start storing the video data in the storage when the additional information with copy prohibiting information is received, means for instructing to start reproducing the video data stored in the storage before end of the storing, and means for erasing the video data in the storage immediately after information of the end of storing is received.

The data recording/reproducing device according to the present invention has the means for instructing to start storing the video data in the storage when the additional information with copy prohibiting information is received, and the means for instructing to start reproducing the video data stored in the storage before end of the storing, and therefore, is capable of performing concurrently storing and reproducing of the video data when the processor receives the additional information with copy prohibiting information. Further, since the device has the means for erasing the video data in the storage immediately after information of the end of storing is received, the stored video data is prohibited from being copied, and thus, the condition of “copy prohibition” is satisfied. Accordingly, when the copy prohibiting information is added to the received analog video signal, the time shift reproducing is performed while the contents-provider's intention of “copy prohibition” is reflected.

It is preferable that the means for erasing the video data in the storage includes means for erasing from the storage a reproduced portion of the video data in the storage immediately after reproduction, and means for erasing the video data in the storage when reproduction has not been started before the end of storing or when reproducing the video data is not being performed at the time of the end of storing. By the means for erasing from the storage a reproduced portion of the video data in the storage immediately after reproduction, the contents-provider's intention is reflected at the time of time shift reproducing. Meanwhile, by the means for erasing the video data in the storage, storing the video data is only carried out, and the contents-provider's intention is reflected also when the time shift reproducing is not carried out.

Another data recording/reproducing device according to the present invention is a data recording/reproducing device provided with a processor for receiving data including analog video data and additional information to control a copy of the video data and for processing the data, and is characterized in that the processor comprises a storage capable of storing the received video data, means for instructing to start storing the video data in the storage irrespective of content of the additional information, means for instructing to start reproducing the video data stored in the storage before end of the storing, and means for erasing the video data in the storage immediately after information of the end of storing is received when the additional information has copy prohibiting information.

In the another data recording/reproducing device according to the present invention, since the processor has the means for instructing to start storing the video data in the storage irrespective of the content of the additional information, and the means for instructing to start reproducing the video data stored in the storage before end of the storing, it is possible to perform storing and reproducing of the video data at the same time irrespective of the content of the additional information. Further, since the processor has the means for erasing the video data in the storage immediately after information of the end of storing is received when the additional information has the copy prohibiting information, the stored data is prohibited from being copied when the additional information has the copy prohibiting information, and thus the condition of “copy prohibition” is satisfied. Accordingly, when the copy prohibiting information is added to the received analog video signal, it is possible to perform the time shift reproducing while the contents-provider's intention of “copy prohibition” is reflected.

It is preferable that the means for erasing the video data in the storage includes means for erasing from the storage a reproduced portion of the video data in the storage immediately after reproduction when the additional information has the copy prohibiting information, and means for erasing the video data in the storage when reproduction has not been started before the end of storing or when reproducing the video data is not being performed at the time of the end of storing, if the additional information has the copy prohibiting information. In this way, the contents-provider's intention is reflected at the time of time shift reproducing, while the contents-provider's intention is reflected also when the time shift reproducing is not performed.

A data processing method according to the present invention is a data processing method including a processing step of processing input data including analog video data and additional information to control a copy of the video data, and is characterized in that the processing step includes a step of instructing to start storing the video data in a storage capable of storing the input video data when additional information with copy prohibiting information is inputted, and a step of instructing to start reproducing the video data stored in the storage before end of the storing and then erasing from the storage a reproduced portion of the video data immediately after reproduction, or a step of erasing the video data in the storage when reproduction has not been started before the end of storing or when reproducing the video data is not being performed at the time of the end of storing.

In the data processing method according to the present invention, in the case where the additional information with copy prohibiting information is inputted, when starting storing the video data in the storage is instructed and then starting reproducing the video data stored in the storage is instructed before end of the storing, the reproduced portion of the video data is erased from the storage immediately after reproduction. Further, when starting storing the video data is instructed and then reproduction has not been started before the end of storing or reproducing the video data is not being performed at the time of the end of storing, the video data in the storage is erased. Accordingly, the time shift reproducing can be performed when the copy prohibiting information is added to the input analog video signal, while the contents-provider's intention of “copy prohibition” is reflected irrespective of whether or not the time shift reproducing is performed.

Another data processing method according to the present invention is a data processing method including a processing step of processing input data including analog video data and additional information to control a copy of the video data, and is characterized in that the processing step includes a step of instructing to start storing the video data in a storage capable of storing the input video data irrespective of content of the additional information, and a step of instructing to start reproducing the video data stored in the storage before end of the storing and then, when the additional information has the copy prohibiting information, erasing from the storage a reproduced portion of the video data immediately after reproduction, or a step of erasing the video data in the storage when reproduction has not been started before the end of storing or when reproducing the video data is not being performed at the time of the end of storing, if the additional information has the copy prohibiting information.

In the another data processing method according to the present invention, when starting storing the video data in the storage is instructed irrespective of the content of the additional information, and then starting reproducing the video data stored in the storage is instructed before end of the storing, the reproduced portion of the video data is erased from the storage immediately after reproduction, if the additional information has the copy prohibiting information. Further, when starting storing the video data in the storage is instructed, the addition information has the copy prohibiting information, and reproduction has not been started before the end of storing or reproducing the video data is not being performed at the time of the end of storing, the video data in the storage is erased. Accordingly, the time shift reproducing can be performed irrespective of the content of the copy control information added to the input analog video signal, while the contents-provider's intention of “copy prohibition” is reflected irrespective of whether or not the time shift reproducing is performed.

A program according to the present invention is a program operable on a computer for processing data including additional information to control a copy of analog video data, and is characterized in that the program comprises the functions for instructing to start storing the video data when the additional information with copy prohibiting information is inputted, instructing to start reproducing the stored video data before end of the storing, and erasing the stored video data immediately after information of the end of storing is inputted.

Another program according to the present invention is a program operable on a computer for processing data including analog video data and additional information to control a copy of the video data, and is characterized in that the program comprises functions for instructing to start storing the video data irrespective of content of the additional information, instructing to start reproducing the stored video data before end of the storing, and erasing the stored video data immediately after information of the end of storing is inputted when the additional information has the copy prohibiting information.

### BRIEF DESCRIPTION OF THE DRAWINGS

FIG. 1 is a block diagram illustrating a functional structure of a processor of a data recording/reproducing device according to an embodiment of the invention;

FIG. 2 is an illustration for explaining an operation of the data recording/reproducing device shown in FIG. 1;

FIG. 3 is another illustration for explaining an operation of the data recording/reproducing device shown in FIG. 1; and

FIG. 4 is a flowchart for explaining an operation of the data recording/reproducing device shown in FIG. 1.

### DESCRIPTION OF THE PREFERRED EMBODIMENT(S)

An embodiment of the present invention will be described specifically below with reference to accompanying drawings.

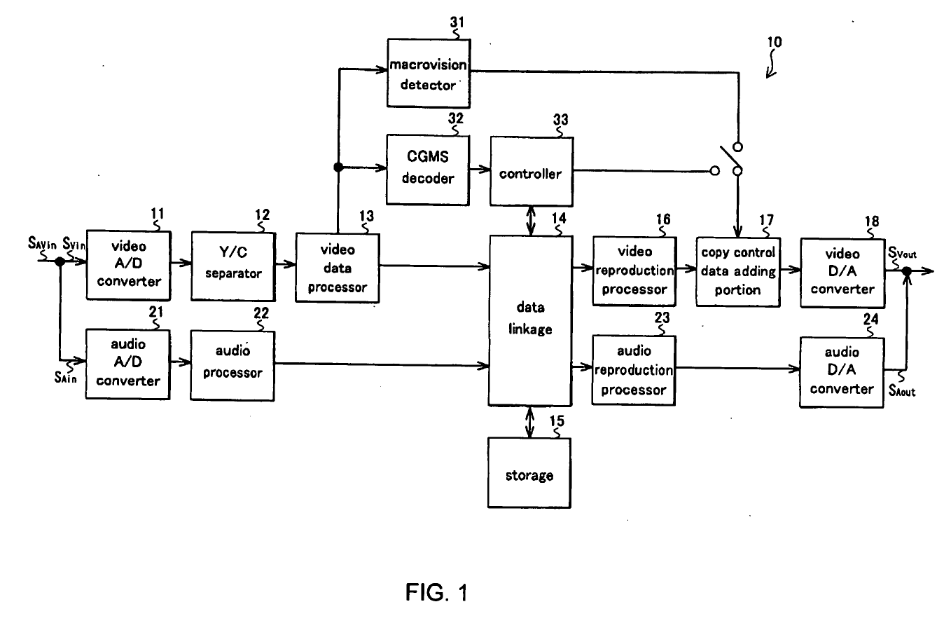

A structure of a data recording/reproducing device according to an embodiment of the present invention will be described first with reference to FIG. 1.

The data recording/reproducing device according to this embodiment is provided with a processor that receives data including analog video data and additional information to control a copy of the video data and processes the data. The device is capable of performing concurrently storing and reproducing of video data, and is operable in three operation modes, general recording mode, reproducing mode and temporary recording mode for temporarily recording the data. An example of such a data recording/reproducing device is a television receiver provided with a storage medium enabling digital recording such as a HDD (hard disk drive). In addition, a case is explained herein that data is inputted which includes analog (NTSC) audio video S_{AVin} signal to which is added CGMS data, and when necessary, a macrovision signal. The CGMS data is used for the data recording/reproducing device to judge whether a copy of the received video signal is permitted or prohibited. The macrovision signal is to cause the video signal not to be recorded properly.

FIG. 1 is a block diagram illustrating a functional structure of the processor 10. The processor 10 has a video A/D converter 11 that converts video signal S_{Vin} of analog AV input signal S_{AVin} into a digital signal, a Y/C separator 12 that separates a luminance (Y) signal component and color (C) signal component from the digital video data, a video data processor 13 which performs color demodulation, etc. using the luminance signal and color signal to generate a color difference signal, while extracting the CGMS data and a portion (hereinafter, referred to as a macrovision signal added portion) where a macrovision signal should be added, an audio A/D converter 21 that converts audio signal S_{Ain} of the analog AV input signal S_{AVin} into a digital signal, an audio processor 22 that formats the digital audio data, a data linkage 14 that receives the color difference signal generated in the video data processor 13 and the audio data processed in the audio processor 22, and a data storage 15 that stores the video data and audio data in the recording mode or temporary recording mode.

The data storage 15 has a reproduced data erasing means for erasing from the storage 15 a reproduced portion of the video data immediately after reproduction in the temporary recoding mode, and a stored data erasing means for erasing the video data in the storage 15 when reproduction has not been started before the end of storing or when reproducing the video data is not being performed at the time of the end of storing in the temporary recording mode. The reproduced data erasing means may be provided to erase the data collectively immediately after reproduction of the reproduced data of the program, or to erase the reproduced portion of the data sequentially at the same time as reproduction.

The processor 10 has a macrovision detector 31 which receives the macrovision signal added portion extracted in the video data processor 13 and detects, for example, whether or not a macrovision signal exists, a CGMS decoder 32 which receives the CGMS data extracted in the video data processor 13 and decodes the CGMS data, and a controller 33 that receives the CGMS data from the CGMS decoder 32. In addition, the CGMS data provided to the controller 33 indicates either copy free, permission of one-generation copy, prohibition of more copy, or prohibition of copy.

The controller 33 has a starting storing instructing means for instructing the data linkage 14 to start storing the data of the data linkage 14 in the storage 15, and a starting reproduction instructing means for instructing to start reproducing the video data stored in the storage 15 before end of the storing. The controller 33 further has an erasing reproduced data instructing means for instructing the storage 15 to erase from the storage 15 a reproduced portion of the video data immediately after reproduction in the temporary recording mode, and an erasing stored data instructing means for instructing to erase the video data in the storage 15 when reproduction has not been started before the end of storing or when reproducing the video data is not being performed at the time of the end of storing in the temporary recording mode.

The processor 10 is further provided with a video reproduction processor 16 that generates an RGB signal from the color difference signal, a copy control data adding portion 17 that adds information of the macrovision signal to the generated RGB signal, a video D/A converter 18 that converts the RGB signal into an analog signal to generate analog video output signal S_{Vout}, an audio reproduction processor 23 that processes the formatted audio data, and an audio D/A converter 24 that converts the audio data into an analog signal to generate an analog audio output signal S_{Vout}.

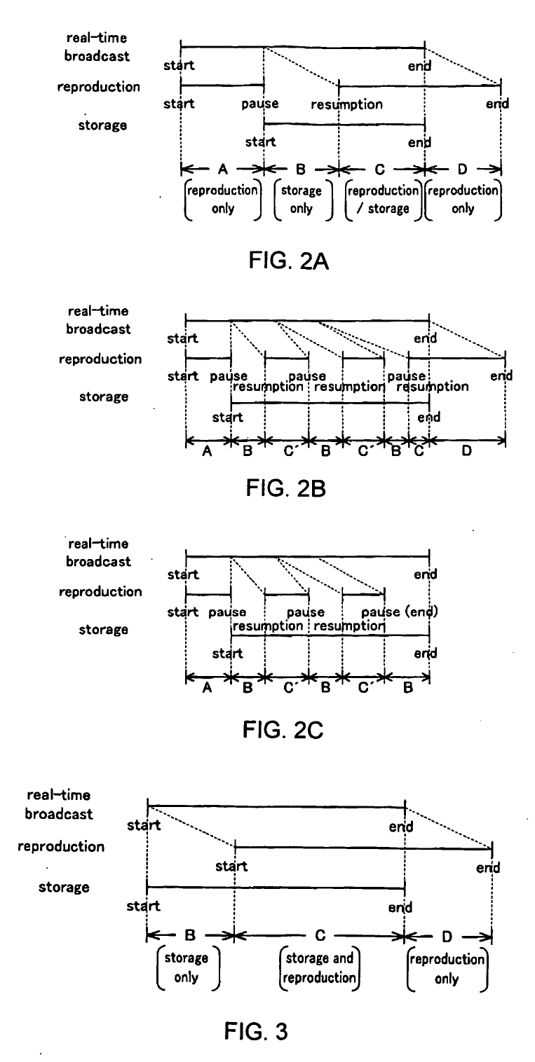

The temporary recording mode in the data recording/reproducing device of this embodiment will be described below with reference to FIGS. 2 to 4. In addition, explanations below also describe a data processing method according to this embodiment.

FIGS. 2A, 2B, and 2C each illustrate the relationship between a real-time broadcast program and viewing of the program of a user, i.e., between reproduction of data (program) in the data recording/reproducing device and storing of the data in the data recording/reproducing device (storage 15) in the temporary recording mode of a type where viewing of a television program on the air is temporarily stopped and then resumed. FIG. 2A indicates the relationship in the case where viewing of the television program on the air is once stopped, while FIGS. 2B and 2C each indicate the relationship in the case where viewing of the television program is stopped three times. FIGS. 2A and 2B each indicate a case of reproducing all the stored data, while FIG. 2C indicates a case of reproducing part of the stored data.

In this type of temporary recording mode, the data recording/reproducing device starts reproducing data concurrently with a start of a real-time broadcast program, and when a user provides a designation for temporarily stopping reproduction and starting storing the data to the device, temporarily stops the reproduction of the data, while concurrently starting storing the data. Then, when the user provides a designation for resuming the reproduction, the device resumes reproducing the data, and performs both storing and reproduction of the data. In the case as shown in FIGS. 2B and 2C, the device repeats thus execution of only storing and execution of both storing and reproduction. Then, the device finishes the storing concurrently with the end of the real-time broadcast program, and in the case as shown in FIGS. 2A and 2B, only performs reproduction. In the case as shown in FIG. 2C, since reproduction is not being performed at the time of the end of storing, a portion of the stored data that is not reproduced is erased by the stored data erasing means in the storage 15 after the end of storing, and cannot be reproduced.

FIG. 3 illustrates the relationship between a real-time broadcast program, reproduction of data (program) in the data recording/reproducing device and storing of data in the data recording/reproducing device (storage 15) in the temporary recording mode of a type where a television program on the air is recorded while reproducing the program from the beginning. In this type of temporary recording mode, the data recording/reproducing device starts storing the data concurrently with a start of the real-time broadcast program, starts reproducing the data when a user provides a designation for starting reproduction to the device, and thus performs both storing and reproduction of the data. Then, concurrently with the end of the real-time broadcast program, the device finishes storing and performs only reproduction.

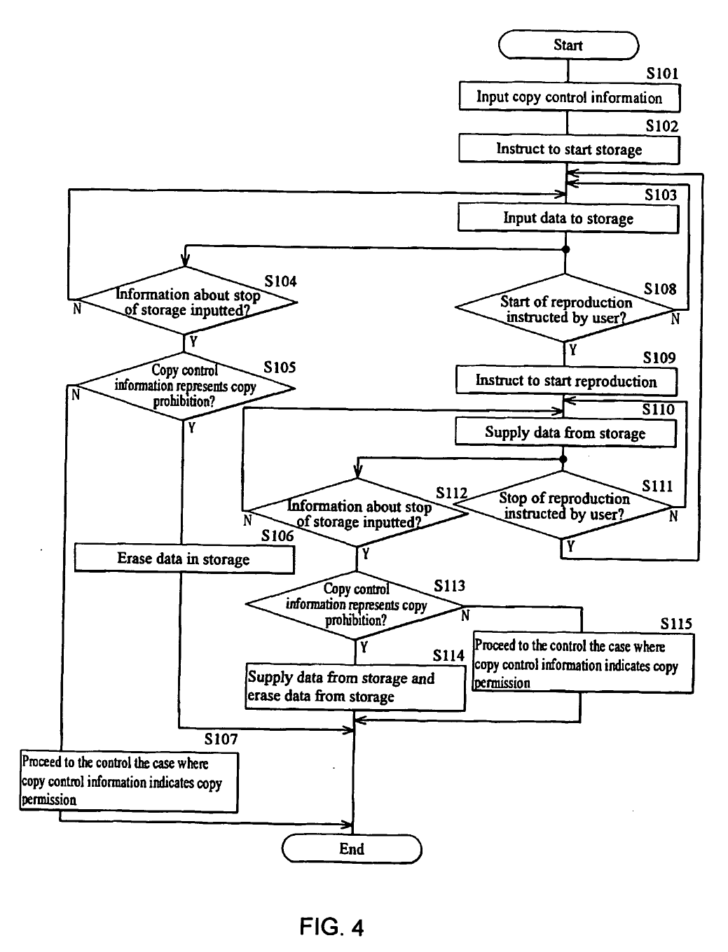

FIG. 4 is a flowchart for explaining the processing in the processor 10 in the temporary recording mode. An interval (interval A in FIG. 2) where the real-time broadcast program and reproduction of data is started and then the reproduction of data is temporarily stopped is the same as in the general reproducing mode, and the processor 10 performs general reproduction processing. In other words, the CGMS data added to the video input signal S_{Vin} is inputted to the controller 33 (step S101 in FIG. 4), and the controller 33 commands the data linkage 14 to output video data and CGMS data, and audio data respectively to the video reproduction processor 16 and audio reproduction processor 23.

Temporarily stopped reproduction of the data can be resumed only during storing of the data (in other words, before the end of storing). During a period of time reproduction of the data is temporarily stopped and then resumed (interval B in FIGS. 2A to 2C and 3), the processor 10 performs storing processing. In other words, when a user provides the designation for temporarily stopping reproduction and starting storing to the device with the CGMS data inputted to the controller 33 (step S101 in FIG. 4), based on the designation, the controller 33 (specifically, the starting storing instructing means) provides an instruction for starting storing (temporarily recording) to the data linkage 14 (step S102). In this way, the data in the data linkage 14 is outputted to the storage 15 (step S103).

When the data in the data linkage 14 is outputted to the storage 15 (step S103), the controller 33 judges whether or not the information of the end of storing is inputted (step S104). Examples of the information of the end of storing include information of the end of the real-time broadcast program and designation of the end of storing by the user. When the information of the end of storing is inputted (step S104; Y), the controller 33 judges whether the input CGMS data has copy permitting information or copy prohibiting information (step S105). When the input CGMS data has the copy prohibiting information (step S105; Y), the controller 33 (specifically, the erasing stored data instructing means) provides to the storage 15 an instruction for erasing the data in the storage 15, and based on the instruction, the storage 15 erases the data (step S106). In this way, when the input CGMS data has the copy prohibiting information, the data in the storage 15 is erased unless reproducing the data has been started before completion of storing.

When the input CGMS data has the copy permitting information (step S105; N), since the data outputted to the storage 15 does not need to be erased from the storage 15, it is not necessary to impose limitations on the reproduction, and the processing flow shifts to processing of the case that the CGMS data has the copy permitting information such as awaiting a designation for starting reproduction by the user (step S107). Meanwhile, when the information of the end of storing is not inputted (step S104; N), the data in the data linkage 14 is outputted to the storage 15 continuously (step S103).

When the data in the data linkage 14 is outputted to the storage 15 (step S103), the controller 33 judges whether or not a user provides a designation for starting reproduction (step S108). When starting reproduction is designated (step S108; Y), the controller 33 (specifically, the starting reproduction instructing means) provides to the storage 15 an instruction for starting (resuming) reproducing the data stored in the storage 15 (step S109). Based on the instruction, the storage 15 supplies the video data and CGMS data to the video reproduction processor 16, and further supplies the audio data to the audio reproduction processor 23 (step S110), and thus, reproducing the data is resumed. Thereafter, during a period of from resuming reproducing the data to the end of the real-time broadcast (interval C in FIGS. 2A, 2B and 3) and during a period of time reproducing the data is resumed and then temporarily stopped (interval C′ in FIGS. 2B and 2C), the processor 10 performs storing processing and reproducing processing. When starting reproduction is not designated (step S108; N), the data in the data linkage 14 is outputted to the storage 15 continuously (step S103).

In a state where the storage 15 is supplying the data as described above (step S110 in FIG. 4), the controller 33 judges whether or not a user designates the end of reproduction (step S111). When the end of reproduction is designated (step S111; Y), the controller 33 provides to the storage 15 an instruction for finishing reproducing the data stored in the storage 15, and based on the instruction, the storage 15 finishes the supply of video data, audio data and CGMS data. In this way, the processor 10 only performs the storing processing, and returns to the state of interval B in FIG. 2 as described above. Meanwhile, when the end of reproduction is not designated (step S111; N), the storage 15 supplies the data continuously as described above (step S110).

In the state where the storage 15 is supplying the data (step S110), the controller 33 judges whether or not the information of the end of storing is inputted (step S112). When the information of the end of storing is inputted (step S112; Y), reproducing the data is only performed (interval D in FIGS. 2A, 2B and 3). In this case, the controller 33 judges whether the input CGMS data has copy permitting information or copy prohibiting information (step S113). When the input CGMS data has the copy prohibiting information (step S113 in FIG. 4; Y), the controller 33 (specifically, the erasing reproduced data instructing means) provides to the storage 15 an instruction for erasing reproduced data from the storage 15 immediately after reproduction, and based on the instruction, the storage 15 supplies the data to a predetermined place and erases the data from the storage 15 immediately after the supply (step S114). In other words, when the input CGMS data has the copy prohibiting information, the data stored in the storage 15 is erased from the storage 15 immediately after reproduction of the data.

When the input CGMS data has the copy permitting information (step S113; N), since the data outputted to the storage 15 does not need to be erased from the storage 15, it is not necessary to impose limitations on the reproduction, and the processing flow shifts to processing of the case that the CGMS data has the copy permitting information (step S115). Meanwhile, when the information of the end of storing is not inputted (step S112; N), the data is supplied from the storage 15 continuously (step S110).

In addition, when reproduction is not being performed at the time of the end of storing and the stored data has a non-reproduced portion as in the type in FIG. 3 which is not shown in FIG. 4, the controller 33 (specifically, the erasing stored data instructing means) provides an instruction for erasing the non-reproduced portion to the storage 15, and based on the instruction, the storage 15 erases the data. In other words, when the input CGMS data has the copy prohibiting information, the non-reproduced data in the storage 15 is erased unless reproduction of data is being performed at the time of the end of storing.

The operation of the data recording/reproducing device with the above-mentioned structure will be described below.

When analog AV input signal S_{AVin} is inputted to which is added CGMS data, and when necessary, a macrovision signal, the video signal S_{Vin} and audio signal S_{Ain} are extracted. The extracted audio signal S_{Ain} is converted into a digital signal in the audio AD converter 21, and is formatted in the audio processor 22. Meanwhile, the extracted video signal S_{Vin} is converted into a digital signal in the video A/D converter 11, separated into a luminance signal component and color signal component in the Y/C separator 12, undergoes predetermined processing in the video data processor 13 to be a color difference signal, and provided to the data linkage 14. The video data processor 13 extracts the CGMS data and macrovision signal added portion, and supplies the CGMS data to the CGMS decoder 32, and the macrovision signal added portion to the macrovision detector 31. The CGMS decoder 32 decodes the CGMS data, and provides the decoded data to the controller 33. The macrovision detector 31 detects whether or not a macrovision signal is added, etc.

Then, in the recording mode, based on the CGMS data in the controller 33, the controller 33 commands the data linkage 14 to output the data in the data linkage 14 to the storage 15. When the command is issued, the CGMS data is supplied to the data linkage 14, and in response to the command, the data linkage 14 outputs the video data, audio data and CGMS information to the data storage 15.

Thus, in the case of reading the video data and audio data stored in the storage 15 to reproduce (read reproduction) in the recording mode, when the read reproduction is instructed, the data storage 15 supplies the video data, audio data and CGMS data to the data linkage 14. Among the data, the audio data is processed in the audio reproduction processor 23, and converted into an analog signal in the audio D/A converter 24, and thus the analog audio output signal S_{Aout} is generated. Meanwhile, the video data is transformed into the RGB signal in the video reproduction processor 16, and supplied to the copy control data adding portion 17. The CGMS data is also supplied to the controller 33, information of the macrovision signal is decompressed from the CGMS data, and the decompressed information of the macrovision signal is fed to the copy control data adding portion 17. The copy control data adding portion 17 adds the information of the macrovision signal to the video data, and supplies the video data, CGMS data and the information of the macrovision signal to the video D/A converter 18. The video D/A converter 18 converts the video data into an analog signal, and thus, analog video output signal S_{Vout} is generated to which is added the CGMS data and information of the macrovision signal, and outputted from the processor 10 together with the analog audio output signal S_{Aout}.

In the mode where analog video input signal S_{Vin} is directly reproduced, based on the CGMS data in the controller 33, the controller 33 commands the data linkage 14 to output the data in the data linkage 14 to the video reproduction processor 16 and audio reproduction processor 23. When the command is issued, the CGMS data is supplied to the data linkage 14, and in response to the command, the data linkage 14 outputs the video data and CGMS information to the video reproduction processor 16, and the audio data to the audio reproduction processor 23. The subsequent processing is the same as in the read reproduction mode as described above except that the macrovision detector 31 feeds a result of detection of macrovision signal to the copy control data adding portion 17.

The temporary recording mode is as described earlier.

Thus, according to this embodiment, when storing the data in the storage 15 is started, then starting reproducing the data stored in the storage is instructed before end of the storing, and the copy control information with copy prohibiting information is added, the reproduced portion of the data is erased from the storage immediately after reproduction. Therefore, irrespective of the content of the copy control information, in other words, even in the case of receiving the additional information with copy prohibiting information, it is possible to perform the time shift reproducing without the data stored in the storage 15 is copied. Further, when reproduction has not been started before the end of storing or reproducing the data is not being performed at the time of the end of storing, the non-reproduced data stored in the storage 15 is erased. Therefore, irrespective of the content of the copy control information, in other words, even in the case of receiving the additional information with copy prohibiting information, it is possible to prohibit the data stored in the storage 15 from being copied. Accordingly, irrespective of the content of the copy control information, in other words, even in the case of receiving the additional information with copy prohibiting information, it is possible to perform the time shift reproducing, and the contents-provider's demand for “copy prohibition” is satisfied irrespective of whether or not the time shift reproducing is performed.

The present invention is described above with the embodiment. However, the present invention is not limited to the above-mentioned embodiment, and is capable of being carried into practice with various modifications thereof. For example, while in the embodiment processing of input data is described as a data recording/reproducing device, the data processing may be executed with software. For example, it may be possible that a data processing program according to the present invention is stored in ROM (Read Only Memory), and according to the program, the operation is performed by instructions of CPU (Central Processing Unit). Further, it may be possible that the program is stored in a computer readable storage medium, the data processing program in the storage medium is recorded in RAM (Random Access Memory) in a computer, and that the operation is performed according to the data processing program. Such cases also provide the same functions and effects as in the above-mentioned embodiment.

Further, the case is described in the embodiment that the CGMS data and macrovision signal added to the analog input signal is inputted, and is processed in the CGMS decoder and macrovision detector respectively. However, additional information added to the analog input signal may include either the CGMS data or macrovision signal, or may be additional information other than information of the CGMS data and macrovision signal. Furthermore, the processor 10 does not necessarily need to have a mechanism for detecting a plurality of additional information, and may have an appropriate detecting mechanism.

As described above, according to the present invention, it is possible that starting storing the video data in the storage is instructed irrespective of the content of the additional information, then starting reproducing the video data stored in the storage is instructed before end of the storing, and that the video data in the storage is erased immediately after information of the end of storing is received, and advantages are thus provided that it is possible to perform the time shift reproducing while satisfying the condition of copy prohibition, when the copy prohibiting information is added to the analog input signal.

This application is based on the Japanese Patent Application No 2002-378245 filed on Dec. 26, 2002, entire content of which is expressly incorporated by reference herein.

1. A data recording/reproducing device provided with a processor for receiving data including analog video data and additional information to control a copy of the video data and for processing the data, characterized in that said processor comprises:
a storage capable of storing the received video data;
means for instructing to start storing the video data in the storage when the additional information with a copy prohibiting information is received;
means for instructing to start reproducing the video data stored in the storage before end of said storing; and
means for erasing the video data in the storage immediately after information of the end of Storing is received.

2. A data recording/reproducing device as claimed in claim 1, characterized in that said means for erasing the video data in the storage includes:
means for erasing from the storage a reproduced portion of the video data in the storage immediately after reproduction; and
means for erasing the video data in the storage when reproduction has not been started before the end of storing or when reproducing the video data is not being performed at the time of the end of storing.

3. A data recording/reproducing device provided with a processor for receiving data including analog video data and additional information to control a copy of the video data and for processing the data, characterized in that said processor comprises:
a storage capable of storing the received video data;
means for instructing to start storing the video data in the storage irrespective of content of the additional information;
means for instructing to start reproducing the video data stored in the storage before end of said storing; and
means for erasing the video data in the storage immediately after information of the end of storing is received when the additional information has copy prohibiting information.

4. A data recording/reproducing device as claimed in claim 3, characterized in that said means for erasing the video data in the storage includes:
means for erasing from the storage a reproduced portion of the video data in the storage immediately after reproduction when the additional information has the copy prohibiting information; and
means for erasing the video data in the storage when reproduction has not been started before the end of storing or when reproducing the video data is not being performed at the time of the end of storing, if the additional information has the copy prohibiting information.

5. A data processing method including a processing step of processing input data including analog video data and additional information to control a copy of the video data, characterized in that said processing step includes:
a step of instructing to start storing the video data in a storage capable of storing the input video data when additional information with copy prohibiting information is inputted; and
a step of instructing to start reproducing the video data stored in the storage before end of said storing and then erasing from the storage a reproduced portion of the video data immediately after reproduction, or a step of erasing the video data in the storage when reproduction has not been started before the end of storing or when reproducing the video data is not being performed at the time of the end of storing.

6. A data processing method including a processing step of processing input data including analog video data and additional information to control a copy of the video data, characterized in that said processing step includes:
a step of instructing to start storing the video data in a storage capable of storing the input video data irrespective of content of the additional information; and
a step of instructing to start reproducing the video data stored in the storage before end of said storing and then, when the additional information has the copy prohibiting information, erasing from the storage a reproduced portion of the video data immediately after reproduction, or a step of erasing the video data in the storage when reproduction has not been started before the end of storing or when reproducing the video data is not being performed at the time of the end of storing, if the additional information has the copy prohibiting information.

7. A program operable on a computer for processing data including additional information to control a copy of analog video data, characterized in that said program comprises the functions for:
instructing to start storing the video data when the additional information with copy prohibiting information is inputted;
instructing to start reproducing the stored video data before end of said storing; and
erasing the stored video data immediately after information of the end of storing is inputted.

8. A program operable on a computer for processing data including additional information to control a copy of analog video data, characterized in that said program comprises functions for:
instructing to start storing the video data irrespective of content of the additional information;
instructing to start reproducing the stored video data before end of said storing; and
erasing the stored video data immediately after information of the end of storing is inputted when the additional information has the copy prohibiting information.
